(19) United States
(12) Patent Application Publication
(10) Pub. No.: US 2010/0163767 A1
(43) Pub. Date: Jul. 1, 2010

(54) Valve

(75) Inventors: Andre-Heinrich Meinhof, Rheinstetten (DE); Armin Steinke, Ettlingen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/668,642

(22) PCT Filed: Jul. 11, 2008
(86) PCT No.: PCT/EP08/59057

§ 371 Date: Jan. 11, 2010

(30) Foreign Application Priority Data
Jul. 11, 2007 (DE) 10 2007 032 639.6

(51) Int. Cl. F01L 3/10; F16K 31/02

(52) U.S. Cl. 251/129.01; 251/337

(57) ABSTRACT

A valve having at least one first valve chamber (1) which has an inlet opening (2) for the supply of a medium and a valve opening (3) which can be closed off by means of a valve body (4), which valve body (4) is acted on by a spring force (F K) which acts in the closing direction and which is generated by a force store (9) which has a spring constant and which valve body (4) can be adjusted counter to the spring force (F K) by means of an actuating element (5) to which an actuating force (F S) which acts counter to the spring force (F K) can be applied at an action point (10), is characterized in that means (7, 8) are provided, by way of which the spring constant which acts at the action point (10) of the actuating force (F S) can be set.

The invention refers to a valve according to the preamble of claim 1 or 2 or 6, with at least one valve chamber which has a first opening for feed of a medium and a second opening which is formed as a valve seat which can be closed off by means of a valve body which is acted upon by a spring force which acts in the closing direction and is created by an energy accumulator which has a spring constant, and which valve body is adjustable against the spring force by means of an actuating element upon which an actuating force, which acts against the spring force, can be applied at a point of action, wherein means are provided by means of which the spring constant, which is effective at the point of action of the actuating force, is adjustable.

Such a valve is known for example from DE 33 10 271 A1. The known valve is used in multifarious ways. In particular, such a valve is used in a position controller for operating a process valve. By means of the position controller, which is frequently formed as an electropneumatic position controller, the position or movement of the drive of the process valve is influenced. This takes place by air being introduced into a chamber in which is arranged a membrane which is connected to the valve body of the process valve. In dependence upon the pressure which is created in the chamber as a result of this, the membrane is adjusted and consequently the valve body of the process valve.

Since for driving large process valves correspondingly large chambers are also used, position controllers for large process valves must ensure a large throughflow of air in order to achieve short reaction times.

A large throughflow of air, however, in the case of position controllers for small process valves which have small chambers, is unfavorable since the correspondingly necessary small volumes of air for adjusting the membrane with position controllers with a large throughflow of air are adjustable only with great difficulty. In other words, the characteristic curve of the position controller or of the valve which is used in the position controller is too steep. If the throughflow of air of a position controller in proportion to the size of the chamber of the process valve drive is too great, it can even lead to vibrating of the system.

It is known to limit the throughflow of air by means of variable restrictors. Limiting the throughflow of air by means of variable restrictors, however, has proved to be unsatisfactory. Since only the maximum throughflow of air is limited by means of the restrictor, changes of the position of the position controller specifically have almost no effect if the throughflow of air is at the limit, and have an almost unaltered effect if the throughflow of air is below the limit. That is to say, in the case of throughflows of air below the limit a behavior change of the position controller can hardly be established. The characteristic curve of the position controller, therefore, cannot essentially be altered by means of a restrictor.

In order to be able to ensure an orderly function of controlling the process valve, the position controller must therefore be adapted to the process valve. That is to say, the throughflow of air or the characteristic curve of the position controller must be adapted to the volume of the chamber in which the membrane for adjusting the valve body of the process valve is located. This is very disadvantageous since as result of this a multiplicity of different position controllers must be used which naturally also necessitates the production of a multiplicity of different position controllers. The fact that the latter is also very disadvantageous is obvious.

A thermostatically controlled valve with all the features of the preamble of claim 1 or 2 or 6 is known from DE 1 032 993 A, in which a rocker, which is pivotable around an imaginary pivot axis, is arranged between the actuating element and the energy accumulator and the energy accumulator is adjustable along the rocker.

Furthermore, a fluid pressure-operated controller with a valve with all the features of the preamble of claim 1 or 2 or 6 is known from DE 30 10 199 A1, in which a rocker, which is pivotable around an imaginary pivot axis, is arranged between the actuating element and the energy accumulator and the pivot axis is adjustable along the rocker.

Furthermore, a further valve with all the features of the preamble of claim 1 or 2 or 6 is known from DE 2 649 520 A1.

It is the object of the invention to form a valve which is referred to in the introduction in such a way that its characteristic curve can be altered in a simple manner.

The achieving of this object results from the features of the characterizing part of claim 1. Advantageous developments of the invention result from the dependent claims.

According to the invention, a valve with at least one valve chamber which has an inlet opening for feed of a medium and a valve opening which is preferably formed as a valve seat and which can be closed off by means of a valve body which is acted upon by a spring force which acts in the closing direction and is created by an energy accumulator which has a spring constant, and which valve body is adjustable against the spring force by means of an actuating element upon which an actuating force, which acts against the spring force, can be applied at a point of action, wherein means are provided by means of which the spring constant, which is effective at the point of action of the actuating force, is adjustable, is characterized in that the energy accumulator is formed as a leaf spring which is clamped on one side and by its end which lies opposite the clamping point acts with force upon the valve body, wherein the distance between the clamping point and the point at which the leaf spring acts with force upon the valve body is adjustable.

Furthermore, according to the invention is a valve with at least one valve chamber which has an inlet opening for feed of a medium and a valve opening which is preferably formed as a valve seat and which can be closed off by means of a valve body which is acted upon by a spring force which acts in the closing direction and is created by an energy accumulator which has a spring constant, and which valve body is adjustable against the spring force by means of an actuating element upon which an actuating force, which acts against the spring force, can be applied at a point of action, wherein means are provided by means of which the spring constant, which is effective at the point of action of the actuating force, is adjustable, is characterized in that the energy accumulator is formed as a leaf spring which in its center region rests on a support at a support point, and by one end abuts against an abutment and also by its end which lies opposite the abutment acts with force upon the valve body, wherein the abutment is adjustable along the leaf spring.

Furthermore, according to the invention is a valve with at least one valve chamber which has an inlet opening for feed of a medium and a valve opening which is preferably formed as a valve seat and which can be closed off by means of a valve body which is acted upon by a spring force which acts in the closing direction and is created by an energy accumulator which has a spring constant, and which valve body is adjustable against the spring force by means of an actuating element upon which an actuating force, which acts against the spring force, can be applied at a point of action, wherein means are provided by means of which the spring constant, which is effective at the point of action of the actuating force, is adjustable, is characterized in that a rocker, which is pivotable around an imaginary pivot axis, is arranged between the actuating element and the energy accumulator and the pivot axis is adjustable along the rocker, and also the rocker is mounted on a pedestal, wherein the pedestal and/or the energy accumulator are arranged on an inclined plane, along which they are adjustable.

As a result of means being provided by means of which the spring constant which is effective at the point of action of the actuating force is adjustable, the characteristic curve of the valve can be altered in a simple manner, because the characteristic curve of the valve depends directly upon the spring constant which is effective on the actuating element of the valve.

If the spring constant which is effective on the actuating element of the valve is large, a large force has to be applied for adjusting the valve body. This means that small force changes bring about only a small adjustment of the valve body. The characteristic curve of the valve therefore has a low gradient. If the spring constant which is effective on the actuating element of the valve is small, however, only a small force needs to be applied for adjusting the valve body. This results in small force changes bringing about a relatively large adjustment of the valve body. The characteristic curve is therefore steep.

The actuating element of the valve can be a pushpin which is connected to the valve body, the point of action, at which the actuating force is applied, being located on the end of the pushpin which faces away from the valve body. The applying of the actuating force can be carried out by means of any generating or transmitting means. In particular, creation of the force can be carried out by means of a piston which is arranged in a cylinder and is connected to the pushpin. By creating a pressure in the cylinder a force is exerted upon the piston which it transmits to the pushpin. By altering the piston face which is exposed to the pressure which prevails in the cylinder, the ratio of the pressure which prevails in the cylinder to the force which acts upon the piston can be adjusted. If the pressure which prevails in the cylinder is taken as the inlet value of the valve, by altering the face of the piston which is exposed to the pressure which prevails in the cylinder, the characteristic curve of the valve can be altered. The effective spring constant is therefore defined as the ratio of the change of the pressure which prevails in the cylinder to the traveled distance of the valve body.

It is very advantageous that the energy accumulator is formed as a leaf spring which on one side is clamped and by its end which lies opposite the clamping point acts with force upon the valve body, wherein the distance between the clamping point and the point at which the leaf spring acts with force upon the valve body, that is to say the point of application of the force, is adjustable. The leaf spring is advantageously arranged in a movable block, as a result of which the distance can be altered in a simple manner. Such an embodiment can be produced particularly easily.

The characteristic curve of the valve, however, can advantageously also be adjusted by the energy accumulator being formed as a leaf spring which in its center region rests on a support at a support point and by one of its ends abuts against an abutment, and also by its end which lies opposite the abutment acts with force upon the valve body, wherein the abutment is adjustable along the leaf spring. If the distance of the point of application of the abutment upon the leaf spring from the support point of the leaf spring on the support is large, the spring constant which is effective on the valve body is small. If the distance is small, the spring constant is large.

In the case of an embodiment of the invention in which the energy accumulator is formed as a leaf spring which in its center region rests on a support at a support point and by one of its ends abuts against an abutment, and also by its end which lies opposite the abutment acts with force upon the valve body, the spring constant can also be adjusted by the support point being adjustable along the leaf spring. By adjustment of the support point along the leaf spring the spring constant which acts upon the valve body can be adjusted in a simple manner, because the ratio of the force which is exerted upon the leaf spring for flexing the leaf spring, that is to say the spring constant, depends upon the distance of the point at which the valve body is acted upon with force by the leaf spring, that is to say upon the distance of the point of application of the force, to the support point of the leaf spring. If the distance is small, the spring constant which is effective on the valve body is large. If the distance is large, the spring constant is small.

In the case of a rigid connection of the valve body to the actuating element, the spring constant which acts upon the valve body is also effective at the point of action of the actuating element. Therefore, the spring constant which is effective at the point of action of the actuating element can be adjusted by an adjustment of the support point of the leaf spring on the support along the leaf spring.

The adjustment of the abutment can be carried out instead of, or in addition to, an adjustment of the support point of the leaf spring on the support. If it is carried out in addition, the spring constant which acts upon the valve body, and consequently the spring constant which is effective at the point of action of the actuating force, can be very accurately adjusted over a wide range.

The support and/or the abutment are advantageously arranged on an inclined plane. As a result of this, a change of the force which acts upon the valve body in its neutral position, which is brought about by the adjustment of the support and/or of the abutment, can be compensated if necessary. Furthermore, nonlinearities can also be compensated as a result of this.

In the case of a further embodiment of the invention, provision is made for the width of the leaf spring to change along the leaf spring. Changing the width of the leaf spring can be carried out linearly or for example according to a parabolic or hyperbolic function. Also as a result of this, nonlinearities which are brought about when adjusting the support or the abutment can be compensated. Moreover, a desired characteristic of the spring constant can be adjusted.

The characteristic curve of the valve can advantageously also be adjusted by a rocker, which is pivotable around an imaginary pivot axis, being arranged between the actuating element and the energy accumulator, wherein the pivot axis is adjustable along the rocker, and also by the pivot axis being mounted on a pedestal which is arranged on an inclined plane, and/or by the energy accumulator being arranged on an inclined plane, upon which it is adjustable. As a result of this, a change of the force which acts upon the valve body in its neutral position, which is brought about by the adjustment of the pivot axis and/or of the energy accumulator along the rocker, can be compensated if necessary. Furthermore, as a result of this, nonlinearities can also be compensated. Instead of as a leaf spring, the energy accumulator can be formed for example as a helical spring or a similarly acting element.

As a result of this, the spring constant of the energy accumulator is not altered but,—because of the transmission ratio of the rocker, only the spring constant which is effective at the point of action of the actuating element is altered. If the distance of the point of action of the actuating force from the pivot axis is just as large as the distance between the pivot axis and the point at which the force is introduced into the valve body, the spring constant which is effective at the point of action corresponds to the spring constant of the energy accumulator. If the distance of the point of action from the pivot axis is greater than the distance of the pivot axis from the point at which the pivot axis is in functional communication with the valve body, the spring constant which is effective at the point of action is smaller than the spring constant of the energy accumulator. If the distance of the point of action from the pivot axis is less than the distance of the pivot axis from the point at which the pivot axis is in functional communication with the valve body, the spring constant which is effective at the point of action is larger than the spring constant of the energy accumulator.

Instead of the adjustment of the pivot axis or in addition to adjustment of the pivot axis, the energy accumulator can be formed with capability of adjustment along the rocker. As a result of this, the spring constant which is effective at the point of action of the actuating force can be very accurately adjusted over a wide range.

Further details, features and advantages of the present invention result from the subsequent description of a particular exemplary embodiment with reference to the drawings.

In the drawing

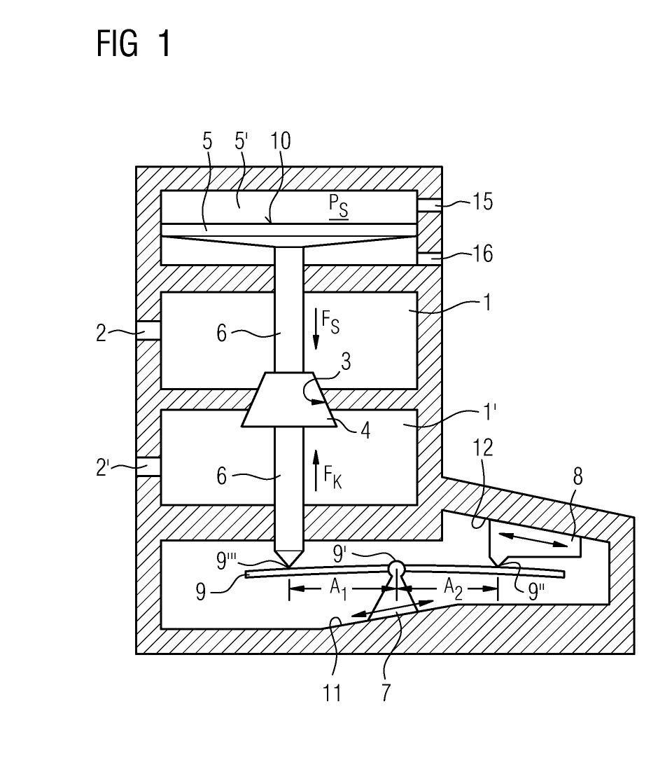

FIG. 1 shows a first embodiment of a valve which is formed according to the invention, in schematic view,

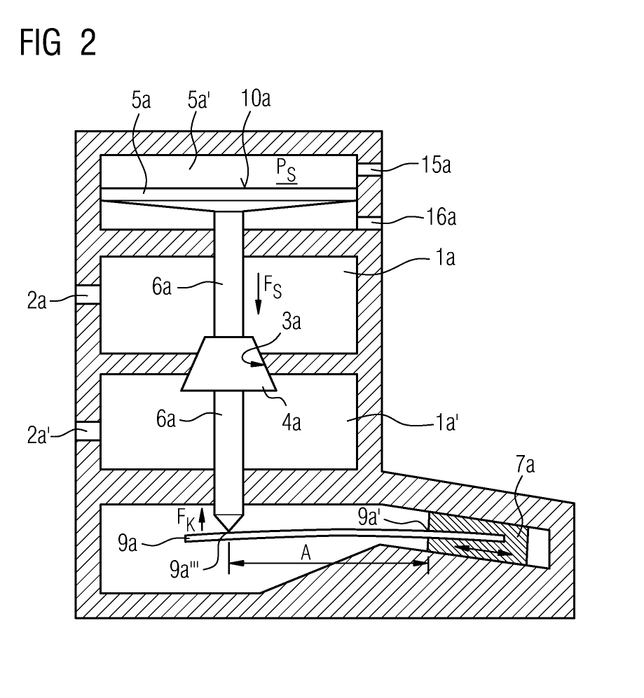

FIG. 2 shows a second embodiment of a valve which is formed according to the invention, in schematic view,

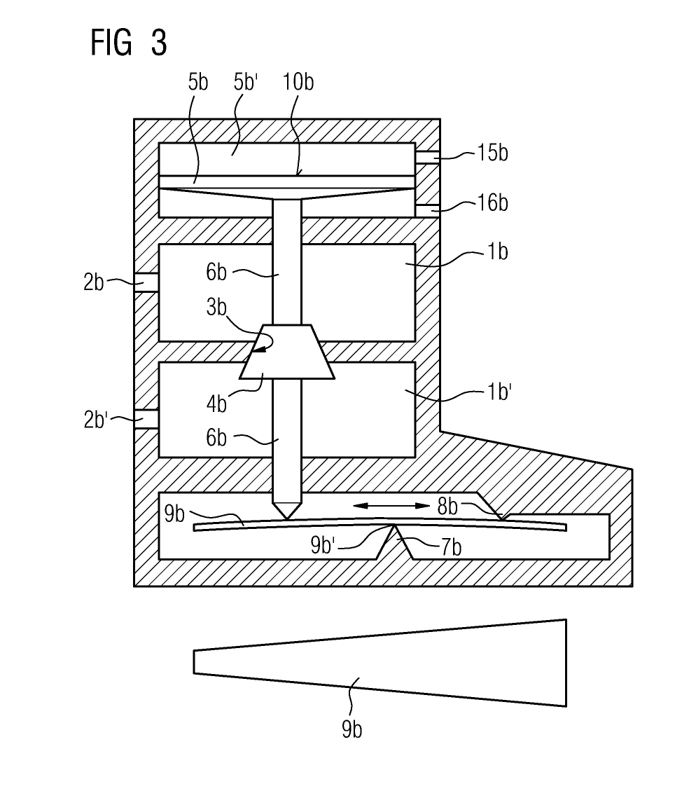

FIG. 3 shows a third embodiment of a valve which is formed according to the invention, in schematic view,

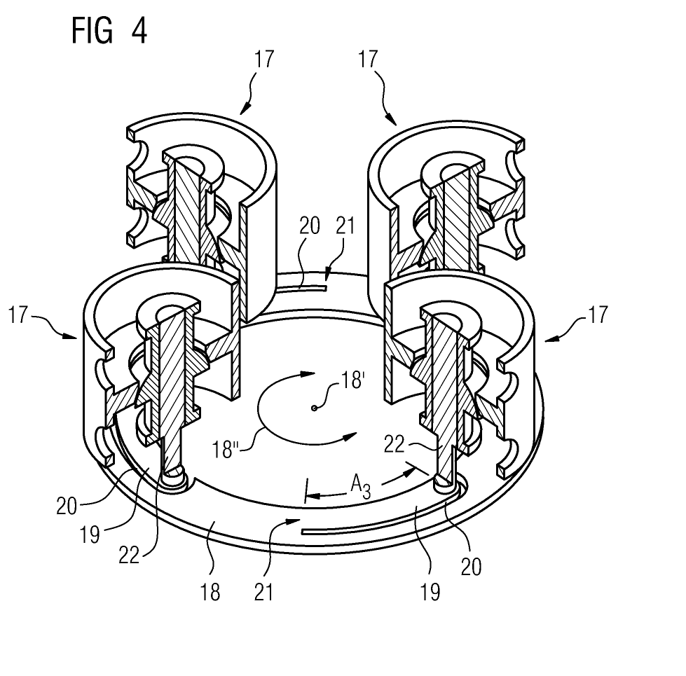

FIG. 4 shows an arrangement with four valves which are formed according to the invention, in schematic view,

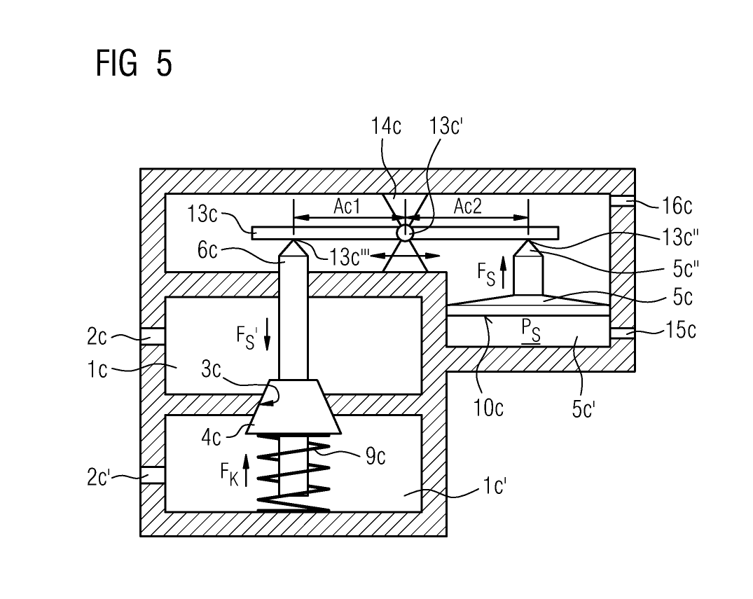

FIG. 5 shows a fourth embodiment of a valve which is formed according to the invention, in schematic view, and

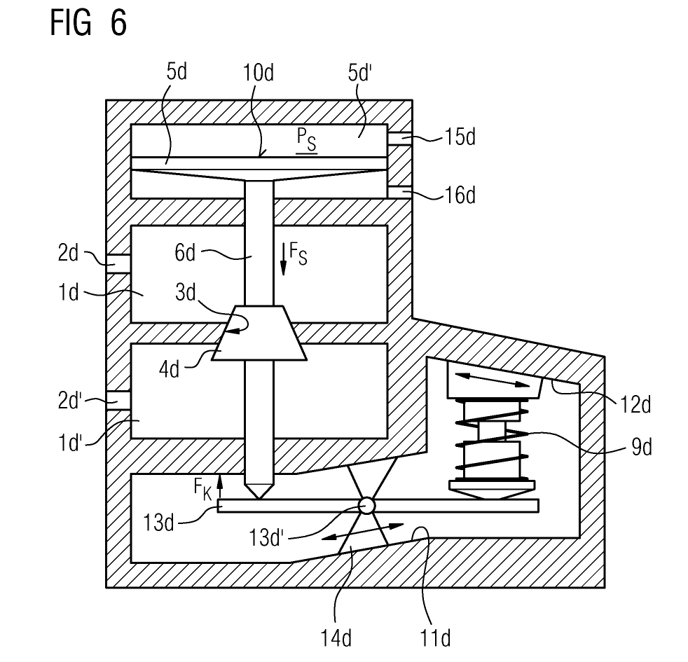

FIG. 6 shows a fifth embodiment of a valve which is formed according to the invention, in schematic view.

As can be gathered from FIG. 1, a valve has a first valve chamber 1 to which a medium, such as compressed air, can be fed by means of an inlet opening 2. The first valve chamber 1 is connected via a valve opening 3 to a second valve chamber 1′. The valve opening 3 can be closed off by means of a valve body 4 which is arranged on a pushpin 6.

At the lower end in the figure, the pushpin 6 is acted upon by a spring force F_{K} which is created by a leaf spring 9. In its center region the leaf spring 9 rests on a support 7 at a support point 9′. The support 7 is arranged on a first inclined plane 11, along which it is adjustable. By the end which faces away from the pushpin 6, the leaf spring 9, at an abutment point 9″, abuts against an abutment 8 which is formed as a movable bearing.

The arrangement which comprises leaf spring 9, support 7 and abutment 8 is formed so that the leaf spring 9 acts with a basic force upon the pushpin 6 if it is located in its neutral position in which it closes off the valve opening 3. The abutment 8 is arranged on a second inclined plane 12, along which it is adjustable.

By the end which faces away from the leaf spring 9, the pushpin 6 is connected to a piston 5 which is arranged in a cylinder 5′. The cylinder 5′ has a control opening 15 by means of which it can be filled with compressed air, that is to say by means of which the piston face 10 can be acted upon by pressure. The cylinder 5′ furthermore has a ventilation opening 16 through which air can escape from the section in question of the cylinder 5′ during a movement of the piston 5.

By introducing compressed air with a determined pressure P_{S} through the control opening 15 into the cylinder 5′, the piston face 10 of the piston 5 is acted upon by the pressure P_{S} in question. As a result of this, an actuating force F_{S}, which acts against the spring force F_{K}, acts upon the pushpin 6. If the actuating force F_{S} is greater than the spring force F_{K}, the valve body 4 can be adjusted from its neutral position into a working position. The working position of the valve body 4 depends upon the pressure P_{S} which prevails in the cylinder 5′. It is achieved when equilibrium prevails between the control force F_{S} which acts upon the pushpin 6 at the upper end and the spring force F_{K} which acts upon the pushpin 6. In this case, the forces which act upon the free surfaces of the valve body 4 on account of the pressure ratios in the valve chambers 1 and 1′ are disregarded.

That is to say, the adjustment travel of the valve body 4 is of such a value that the spring force F_{K} which is brought about by it on account of the spring constant of the leaf spring 9 corresponds to the actuating force F_{S}. Since a linear correlation exists between the control pressure P_{S} which prevails in the cylinder 5′ and the actuating force F_{S} which is brought about by it, a linear correlation also exists between the control pressure P_{S} and the adjustment travel of the valve body 4, the proportionality factor of which corresponds to the spring constants which are brought about by the leaf spring 9.

In the position of the support 7 and of the abutment 8 which are shown in FIG. 1, the distance A₁ of the point of application 9′″ of the pushpin 6,—at which the pushpin 6 is in functional communication with the leaf spring 9, from the support point 9′ of the leaf spring 9,—at which the leaf spring is in functional communication with the support 7, is approximately just as large as the distance A₂ of the abutting point 9″ of the abutment 8,—at which the leaf spring 9 is in functional communication with the abutment 8, from the support point 9′ of the leaf spring 9. As a result of this, a force with a corresponding first spring constant opposes the control pressure P_{S} which prevails in the cylinder 5′.

By shifting the support 7, and consequently the support point 9′, along the leaf spring 9, the distances A₁, A₂ can be altered, as a result of which the spring constant which is effective at the point of application 9′″ of the pushpin 6 is altered, which results in the spring constant which acts against the actuating force F_{S}, and consequently against the control pressure P_{S} which prevails in the cylinder 5′, being altered.

The spring constant which exists at the point of application 9′″ of the pushpin 6 can also be altered by the abutment 8 being shifted along the leaf spring 9, because as a result the distance A₂ of the abutting point 9″ of the abutment 8 on the leaf spring 9 from the support point 9′ of the leaf spring 9 on the support 7 is altered.

As a result of the first inclined plane 11, along which the support 7 can be shifted, and also as a result of the second inclined plane 12, on which the abutment 8 can be shifted, the effect can be achieved of the spring force F_{K} which acts upon the valve body 4 in the neutral position of the valve body 4 remaining unaltered despite altering the spring constant.

If the valve body 4 is located in a working position, the medium which is fed to the first valve chamber 1 via the inlet opening 2 reaches the second valve chamber 1′ through the valve opening 3, and via the outlet opening 2′ can be supplied to its further application. The volume of medium which is made available via the outlet opening 2′ depends upon the size of the valve opening 3, that is to say upon the position of the valve body 4. Since the position of the valve body 4 depends upon the control pressure P_{S} which prevails in the cylinder 5′, the volume of the medium which is made available per unit of time by means of the outlet opening 2′ depends upon the control pressure P_{S}.

If the spring constant which is effective at the point of application 9′″ of the leaf spring 9 on the pushpin 6 is small, a relatively small actuating force F_{S}, that is to say a relatively low control pressure P_{S}, has to be applied for adjustment of the valve body 4 by a predetermined distance. The valve, therefore, has a relatively steep characteristic curve. If the spring constant which is effective at the point of application 9′″ of the leaf spring 9 on the pushpin 6 is large, a relatively large force F_{S}, that is to say a relatively high control pressure P_{S}, has to be applied for achieving the same adjustment of the valve body 4. The characteristic curve of the valve therefore extends in a relatively flat manner. Since by shifting the support 7 and/or by shifting the abutment the spring constant which is effective at the point of application 9′″ of the leaf spring 9 on the pushpin 6 can be adjusted, by shifting the support 7 and/or the abutment 8 the characteristic curve of the valve can be adjusted.

The embodiment of the invention which is shown in FIG. 2 has essentially the same construction as the embodiment which is shown in FIG. 1. Similar elements are therefore provided with the same designations; for differentiation, however, they additionally feature the letter a.

In contrast to the embodiment which is shown in FIG. 1, in the case of the embodiment which is shown in FIG. 2 the leaf spring 9a is clamped on one side in a block 7a. The block 7a is movably fastened in the longitudinal direction of the leaf spring 9a.

By shifting the block 7a, the distance A between the clamping point 9a′ of the leaf spring 9a in the block 7a and the point of application 9a′″ of the leaf spring 9a on the pushpin 6a can be adjusted. Since the spring constant of the leaf spring 9a which is effective at the point of application 9a′″ of the leaf spring 9a on the pushpin 6a depends upon the distance A of the point of application 9a′″ of the leaf spring 9a on the pushpin 6a from the clamping point 9a′ of the leaf spring 9a in the block 7a, the spring constant can therefore be adjusted by shifting the block 7a. The block 7a is arranged on an inclined plane, along which it is adjustable. As a result of this, the force which acts upon the valve body 4a in the neutral position can be adjusted.

The embodiment of the invention which is shown in FIG. 3 has essentially the same construction as the embodiment which is shown in FIG. 1. Similar elements are therefore provided with the same designations; for differentiation, however, they additionally feature the letter b.

In the case of the embodiment which is shown in FIG. 3, the support 7b and also the abutment 8b are not movably arranged. The leaf spring 9b, however, is movably arranged relative to the support 7b or abutment 8b.

As can be gathered from the plan view of the leaf spring 9b which is also shown in FIG. 3, the width of the leaf spring 9b changes along the leaf spring 9b. As a result of this, the spring constant which is effective at the point of application 9b′″ of the leaf spring 9b on the pushpin 6b can be altered. If the leaf spring 9b is located in a position in which the width of the leaf spring 9b at the point of application 9b′″ of the leaf spring 9b on the pushpin 6b is small, the spring constant which is effective there is correspondingly small. If the width at the said point of application 9b′″ is relatively large, the spring constant is relatively large.

In FIG. 4, a schematic arrangement with four valves 17 which are formed according to the invention is shown. In principle, the construction of the valves 17 essentially corresponds to the construction which is shown in FIG. 2.

As can be gathered from FIG. 4, the arrangement features a metal strip 18 which consists of spring steel and is of an annular design, in which spring tongues 19 are formed by means of separating gaps 20. Above the metal strip 18, the valves 17 are arranged in such a way that their pushpins 22 abut upon the spring tongues 19. By rotating the metal strip 18 around a middle point 18′, the distance A₃ of the points at which the pushpins 22 impact upon the spring tongues 19 to the original points 21 of the spring tongues 19, that is to say the points to which the separating gaps 20 extend, can be adjusted. Since with the distance A₃ the spring constant which acts upon the pushpins 22 is altered, the spring constant which acts upon the pushpins 22, and consequently the characteristic curve of the valves 17, can therefore be adjusted by rotating the metal strip 18. The rotational movement of the metal strip 18 is indicated by means of an arrow 18″.

The embodiment of the invention which is shown in FIG. 5 has partially the same construction as the embodiment of the invention which is shown in FIG. 1. Similar elements are therefore provided with the same designations; for differentiation, however, they additionally feature the letter c.

In the case of the embodiment of the invention which is shown in FIG. 5, the valve body 4c is acted upon by a force F_{K} in the closing direction of the valve opening 3c by means of a helical spring 9c. At the end which lies opposite the helical spring 9c, a force F_{S}′ is exerted upon the pushpin 6c by means of a rocker 13c which is pivotable around a pivot axis 13c′, which force is introduced into the rocker 13c at the end of the rocker 13c which lies opposite the pushpin 6c by means of a point 5c″ which is arranged on the piston 5c. The control pressure P_{S} which prevails in the cylinder 5c′ acts upon the piston face 10c. The rocker 13c is mounted by its pivot axis 13c′ in a pedestal 14c. The pedestal 14c or the pivot axis 13c′ can be adjusted along the rocker 13c. As a result of this, the transmission ratio of the rocker 13c can be altered.

In contrast to the previously described embodiments of the invention, in the case of the embodiment of the invention which is shown in FIG. 5 the actuating force F_{S} which is created by means of the control pressure P_{S} which is present in the cylinder 5c′ does not therefore act directly upon the pushpin 6c of the valve body 4c but via the rocker 13c which is pivotable around the pivot axis 13c′.

In the case of the position which is shown in FIG. 5, the distance A_{C1}, of the point of application 13c′″ of the pushpin 6c on the rocker 13c from the pivot axis 13c′ is approximately just as large as the distance A_{C2} of the point of application 13c″ of the piston point 5c″ from the pivot axis 13c′. That is to say, the transmission ratio of the pivot axis 13c is approximately one, which results in the control force F_{S}′ which is effective on the pushpin 6c being just as large as the force F_{S} which is exerted by the piston point 5c″ upon the rocker 13c on account of the control pressure P_{S} which prevails in the cylinder 5c′.

If the pedestal 14c or the pivot axis 13c′ is shifted along the rocker 13c for example in the direction of the pushpin 6c, the distances A_{C1}, A_{C2}, and consequently the transmission ratio of the rocker 13c, are altered.

In the case of a shift of the pedestal 14c or of the pivot axis 13c′ in the direction of the pushpin 6c, the spring constant which is effective at the piston point 5c″, and consequently the spring constant which opposes the control pressure PS, is reduced, which results in the small pressure changes already bringing about a relatively large adjustment of the valve body 4c. That is to say, the valve has a relatively steep characteristic curve.

In the case of a shift of the pedestal 14c or of the pivot axis 13c′ in the direction of the pushpin 6c, the spring constant which is effective at the piston point 5c″, and consequently the spring constant which opposes the control pressure P_{S}, is increased, which results in the small pressure changes bringing about only a small adjustment of the valve body 4c. That is to say, the valve has a characteristic curve which extends in a relatively flat manner.

The embodiment of the invention which is shown in FIG. 6 partially corresponds to the embodiment which is shown in FIG. 1. Similar elements are therefore provided with the same designations; for differentiation, however, they additionally feature the letter d.

In the case of the embodiment of the invention which is shown in FIG. 6, in the same way as in the case of the embodiments of the invention which are shown in FIG. 1, an actuating force F_{S} is exerted directly upon the pushpin 6d by means of a pressure which prevails in the cylinder 5d′, which actuating force acts against the spring force F_{K} which is exerted upon the pushpin 6 at the opposite end of the pushpin 6. In contrast to the embodiment of the invention which is shown in FIG. 1, the spring force F_{K}, however, is not created by a leaf spring but by a helical spring 9d and is introduced into the pushpin 6d via a rocker 13d which is pivotable around a pivot axis 13d′. The rocker 13d is mounted by its pivot axis 13d′ in a pedestal 14d. The pedestal 14d or the pivot axis 13d′ can be adjusted along the rocker 13d. As a result of this, the transmission ratio of the rocker 13d can be altered.

The pedestal 14d is arranged on a third inclined plane 11d, along which it is adjustable. As a result of this, the spring force F_{K} which acts upon the valve body 4d in the neutral position can be adjusted.

By altering the transmission ratio of the rocker 13d, the spring constant which acts upon the pushpin 6d can be altered corresponding to the embodiment which is shown in FIG. 5.

If the pedestal 14d or the pivot axis 13d′ is shifted along the rocker 13d for example in the direction of the pushpin 6d, the spring constant which is effective on the pushpin 6d is increased, which results in a large actuating force F_{S}, and consequently a high control pressure P_{S}, already being necessary for a relatively small adjustment of the valve body 4d. That is to say, the valve has a characteristic curve which extends in a relatively flat manner.

In the case of an adjustment of the pivot axis 13d′ or of the pedestal 14d in the direction of the compression spring 9d, the spring constant which is effective on the pushpin 6d is reduced. As a result of this, a small alteration of the actuating force F_{S} or of the control pressure P_{S} already effects a relatively large adjustment of the valve body 4d.

That is to say, the valve then has a relatively steep characteristic curve.

The spring constant which is effective on the pushpin 6d can also be altered by adjusting the compression spring 9d along the rocker 13d. By adjusting the compression spring 9d in the direction of the pivot axis 13d′, the spring constant which is effective on the pushpin 6d is reduced. By adjusting the compression spring 9d in the opposite direction, the spring constant which is effective on the pushpin 6d is increased.

The compression spring 9d is arranged on a fourth inclined plane 12d, along which it is adjustable. As a result of this, the spring force F_{K} which acts upon the valve body 4d in the neutral position can be adjusted.

1.-8. (canceled)

9. A valve, comprising:
at least one first valve chamber having an inlet opening for feed of a medium and a valve opening;
an energy accumulator having a spring constant for creating a spring force;
a valve body movable to open and close the valve opening, the valve body being acted upon by the spring force acting in a closing direction of the valve body;
an actuating element configured to receive an actuating force which acts against the spring force; and
means for adjusting the spring constant, said adjusting means being effective at the point of action of the actuating force;
wherein the energy accumulator comprises a leaf spring which is clamped on one side and acts with the spring force upon the valve body at an end disposed opposite the clamping point, and wherein a distance between the clamping point and another point at which the leaf spring acts with the spring force upon the valve body is moveable along a path of the leaf spring.

10. A valve, comprising:
at least one first valve chamber having an inlet opening for feed of a medium and a valve opening;
an energy accumulator having a spring constant for creating a spring force;
a valve body movable to open and close the valve opening, the valve body being acted upon by the spring force in a closing direction of the valve body; and
an actuating element configured to receive an actuating force which acts against the spring force;
means for adjusting the spring constant, said adjusting means being effective at the point of action of the actuating force;
wherein the energy accumulator comprises a leaf spring which rests at its center region on a support located at a support point, at one end abuts against an abutment and at another end which is disposed opposite to the abutment acts with the spring force upon the valve body, and wherein the abutment is movable along the leaf spring.

11. The valve as claimed in claim 10, wherein the support point is movable along the leaf spring.

12. The valve as claimed in claim 10, wherein at least one of the support and the abutment is arranged on an inclined plane, upon which the at least one of the support and the abutment is movable.

13. The valve as claimed in claim 11, wherein at least one of the support and the abutment is arranged on an inclined plane, upon which the at least one of the support and the abutment is movable.

14. The valve as claimed in claim 9, wherein a width of the leaf spring changes along a length of the leaf spring.

15. A valve, comprising:
at least one first valve chamber having an inlet opening for feed of a medium and a valve opening;
an energy accumulator having a spring constant for creating a spring force;
a valve body movable to open and close the valve opening, the valve body being acted upon by the spring force in a closing direction of the valve body;
an actuating element configured to receive an actuating force which acts against the spring force;
means for adjusting the spring constant, said adjusting means being effective at the point of action of the actuating force; and
a rocker, which is pivotable about a pivot axis, arranged between the actuating element and the energy accumulator;
wherein the pivot axis of the rocker is movable along a path of the rocker, and the rocker is mounted on a pedestal, and wherein at least one of the pedestal and the energy accumulator is arranged on an inclined plane along which the wherein at least one of the pedestal and the energy accumulator is movable.

16. The valve as claimed in claim 15, wherein the energy accumulator is movable along the rocker.

17. The valve as claimed in claim 9, wherein the valve comprises a component part of an electropneumatic position controller which is configured to operate a process valve.

18. The valve as claimed claim 10, wherein the valve comprises a component part of an electropneumatic position controller which is configured to operate a process valve.

19. The valve as claimed claim 15, wherein the valve comprises a component part of an electropneumatic position controller which is configured to operate a process valve.

20. The valve as claimed in claim 10, wherein a width of the leaf spring changes along a length of the leaf spring.
